(19) United States
(12) Patent Application Publication
(10) Pub. No.: US 2008/0308422 A1
(43) Pub. Date: Dec. 18, 2008

(54) Protein Sample Preparation

(75) Inventors: Reginald Donovan Smith, Schenectady, NY (US); Erin Jean Finehout, Clifton Park, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: GENERAL ELECTRIC COMPANY, Schenectady, NY (US)

(21) Appl. No.: 11/762,564

(22) Filed: Jun. 13, 2007

(51) Int. Cl. G01N 27/26; G01N 1/38; G01N 37/00

(52) U.S. Cl. 204/450; 436/18; 436/86

(57) ABSTRACT

In one aspect, the invention provides methods for protein sample preparation for electrophoretic separation. The method comprises a step of providing a protein sample in solution, adding a chaotrope to the protein sample, adding a surfactant to the protein sample, wherein the final concentration of the surfactant in the solution is less than critical micelle concentration of the surfactant. In another aspect, the invention also provides methods of electrophoretic separation of protein samples that includes the protein sample preparation method as described herein. In yet another aspect, the invention provides a loading buffer solution composition for protein sample preparation that includes a surfactant in solution at a final concentration that is less than critical micelle concentration of the surfactant, and; a chaotrope.

### BACKGROUND

The invention relates generally to methods for protein sample preparation for electrophoresis. The invention also relates to electrophoretic methods for protein sample separation and analysis.

Biological samples containing proteins are often subjected to an electrophoretic separation step to characterize, and optionally, quantify the proteins present in a sample. An electric field applied across a substrate or liquid containing a protein sample causes the protein to migrate through the substrate at a velocity that is determined by the protein's charge. In protein electrophoresis the sample is coated with an ionic surfactant such that the charge of the protein is proportional to the size of the protein. The sieving matrix in which the proteins are moving impedes the movement of the proteins in proportion to their size. Thus the velocity of the protein moving in the electric field is proportional to its size. Electrophoretic separation may be accomplished by using a sieving matrix such as a linear or crosslinked polymer in a capillary electrophoresis or slab gel format.

Before electrophoretic separation, proteins are typically reduced to break any disulfide bonds and denatured to remove secondary, and tertiary structural features. Denaturation may be accomplished using one or more compounds (e.g., a surfactant) that interact with the hydrophobic areas of the protein allowing it to unfold in an aqueous environment.

Electrophoresis typically is run at high surfactant levels (i.e. above the critical micelle concentration (cmc)) and the sample preparation methods often use high surfactant levels as well. Operating at surfactant levels above the cmc results in the formation of empty surfactant micelles, which do not contain protein. In some applications, it is desirable or necessary to work below the cmc to minimize the formation of these empty micelles.

### BRIEF DESCRIPTION

In one aspect, the invention provides a method for preparing a protein sample for electrophoresis comprising: (a) providing a protein sample in solution; (b) adding a chaotrope to the protein sample, and (c) adding a surfactant to the protein sample, wherein the final concentration of the surfactant in the solution is less than critical micelle concentration of the surfactant.

In another aspect, the invention provides an electrophoretic method comprising the steps of: (a) providing a protein sample in solution; (b) adding a chaotrope to the protein sample; (c) adding a surfactant to the protein sample, wherein the final concentration of the surfactant in the solution is less than critical micelle concentration of the surfactant; and (d) loading the sample solution of step (c) into an electrophoretic device, and applying an electric current to resolve the components of protein sample.

In yet another aspect, the invention provides a protein sample loading buffer composition comprising a surfactant in solution at a final concentration of the surfactant in the solution is less than critical micelle concentration of the surfactant, and a chaotrope.

### DRAWINGS

These, and other features, aspects, and advantages of the present invention will become better understood when the following detailed description is read with reference to the accompanying drawings in which like characters represent like parts throughout the drawings, wherein:

FIG. 1 shows the SDS PAGE (10%) polyacrylamide gel results for protein samples (˜500 ng/well) that were prepared for electrophoresis in SDS sample loading buffer (including the buffer salts, reducing agent, and surfactant) without urea. Lane 1 (left to right) was loaded with Immunoglobulin G (IgG); Lane 2 Bovine Serum Albumin (BSA), and Lane 3 was loaded with molecular weight marker (Invitrogen BenchMark™ Protein Ladder; Catalog Number-10747).

FIG. 2 shows the electrophoretic migration results for IgG (˜500 ng/well) samples loaded onto an SDS PAGE (10%) polyacrylamide gel. Lane 1 shows the sample in LDS sample loading buffer (including the buffer salts, reducing agent, and surfactant) with 2 M urea; Lane 2 shows the sample in LDS sample loading buffer without the urea; and Lane 3 was loaded with molecular weight marker (Invitrogen BenchMark™ Protein Ladder; Catalog Number-10747).

FIG. 3 shows a pictorial representation of two real-time sample denaturation embodiments. As shown in the 3A, the sample and the buffer (including the buffer salts, chaotrope, and surfactant) are premixed and loaded through a single introducing device (e.g., a syringe). In 3B, the protein sample is introduced through a first syringe; the buffer (including the buffer salts, chaotrope, and surfactant) is introduced through a second syringe, and the sample and buffer are combined in a mixer. In both of these embodiments, the system may also include a heating element (not shown) in-line with or overlaying the syringe or syringes.

FIG. 4 shows the gel electrophoresis migration pattern for IgG using a single syringe as shown in FIG. 3 for heating times from 0, 5, 12, and 17 seconds.

FIG. 5 shows the gel electrophoresis migration pattern two syringes and a mixer as shown in FIG. 3 with 17 seconds of heating as compared to no heating.

FIG. 6 shows a sample containing phosphorylase b, albumin, ovalbumin, carbonic anhydrase, and trypsin inhibitor, loaded onto an SDS PAGE (10%) polyacrylamide gel, wherein the sample LDS sample buffer (including the buffer, chaotrope, and surfactant).

### DETAILED DESCRIPTION

### Definitions

To more clearly, and concisely describe, and point out the subject matter of the claimed invention, the following definitions are provided for specific terms, which are used in the following description, and the appended claims. The singular forms “a”, “an”, and “the” include plural referents unless the context clearly dictates otherwise.

As used herein the term “surfactant” generally refers to organic compounds that are amphiphilic, which reduce the surface interfacial tension between two liquids. Preferred surfactants assemble into micelles or reverse micelles.

As used herein, the phrase “critical micelle concentration” (CMC) is defined as the concentration of surfactants above that the surfactants are present substantially in an aggregated form or micellar form under a given set of conditions. At the vicinity of CMC, sharp change in many experimental parameters may be observed, and this may be measured by a number of techniques that include, but not limited to, surface tension measurements, fluorescence, conductivity, osmotic pressure, and the like. CMC varies as a function of a number of physical factors such as pH, temperature, and pressure.

As used herein, “chaotrope” refers to an agent that causes molecular structure to be disrupted, especially molecular structures formed by nonbonding forces such as hydrogen bonding, van der Waals interactions, and the hydrophobic effect. Chaotropes may be nonionic or ionic in nature. Exemplary nonionic chaotrope is urea, while an exemplary ionic chaotrope is guanidinium hydrochloride.

As used herein, “buffers” are aqueous solutions comprising salts of acids, and bases which resist change in hydronium ion, and the hydroxide ion concentration (and consequently pH) upon further addition of small amounts of acid or base, or upon dilution.

As used herein, “solvatochromic dyes” are dyes that change flurorescence intensity based on the hydrophobicity of their environment. Typically these dyes show a low fluorescence in an aqueous environment, and a high fluorescence in a lipid or hydrophobic environment. This class of dyes includes, but is not limited to, merocyanine dyes and cyanine dyes.

Unless otherwise indicated, all numbers expressing quantities of ingredients, properties such as molecular weight, reaction conditions, so forth used in the specification, and claims are to be understood as being modified in all instances by the term “about.” Accordingly, unless indicated to the contrary, the numerical parameters set forth in the following specification, and attached claims are approximations that may vary depending upon the desired properties sought to be obtained by the present invention. At the very least each numerical parameter should at least be construed in light of the number of reported significant digits, and by applying ordinary rounding techniques.

### Specific Embodiments

In one aspect, the invention provides a method for preparing a protein sample for electrophoresis. The method comprises a step of providing a protein sample in solution. Protein samples that may be used in the invention include any protein or mixture of proteins that have a minimum molecular weight of about 10,000 Daltons.

In one embodiment, the protein sample solution is generally made available in an aqueous medium. In some embodiments, the aqueous medium is a buffer medium such that the final pH of the solution is maintained at a suitable range. Nominal values for pH of the sample may be in the physiological pH range that ranges from, in one embodiment, about 5.5 to about 9.0, and in another embodiment, from about 6.0 to about 8.0. Suitable buffers that may be used for this purpose include, but not limited to, Tris-Borate-EDTA, Tris-HCl, Phosphate Buffered Saline (PBS), citrate buffer, and acetate buffer. Such buffers are commercially sources from a variety of sources such as Sigma-Aldrich Chemical Company, Milwaukee, Wis., USA.

The method of the invention also includes a step of adding a chaotrope to the protein sample. Chaotropes of the invention are nonionic in nature. Exemplary nonionic chaotropes include urea, thiourea, trimethylamine N-oxide, and morpholine N-oxide. The chaotrope may be added in the natural physical state of the compound used, or it may be added as a solution in an appropriate medium, such as buffers. In one embodiment, the chaotrope is added as a solution in the same buffer as the protein sample is made available.

The method of the invention further comprises a step of adding a surfactant to the protein sample. Surfactants useful in the invention are amphiphilic in nature in that they contain a hydrophobic part, and a hydrophilic part. The hydrophobic part may be an alkyl chain such as, but not limited to, a hexyl chain, a decyl chain, and a dodecyl chain. The hydrophilic part may include ionic moieties such as, but not limited to, carboxylates, sulfonates, sulfates and ammonium. Thus, in one embodiment, surfactants useful in the invention include the anionic surfactants such as, but not limited to, sodium dodecyl sulfate (SDS), and lithium dodecyl sulfate (LDS). In further embodiments, combinations of SDS, and LDS may also be used.

The order of addition of the chaotrope, and the surfactants to the protein sample solution is not important. Thus, in one embodiment, the chaotrope is added to the protein sample solution followed by the addition of the surfactant solution. In another embodiment, the surfactant solution is added to the protein sample solution followed by the addition of the chaotrope solution. In yet another embodiment, the surfactant, and the chaotrope are mixed together in solution, which is then added to the protein sample.

When ionic surfactants are added to the protein samples, the surfactants confer a uniform charge to the protein samples, and, in free solution, the ionic complexes have electrophoretic mobilities that are dependent on the size of the protein sample, thus ensuring the separation is effected only through the differences in sizes of the protein samples.

When the ionic surfactants are present at concentrations greater than the critical micelle concentration, they form empty micelles that will migrate under electrophoretic conditions. In some methods of detection (e.g., the use of solvatochromic dyes) the empty micelles will give rise to random or background signals. Thus, it can be advantageous or necessary to use the surfactant at concentrations less than the critical micelle concentrations. The invention provides a method wherein the surfactant is added to the protein samples such that the final concentration of the surfactant in the solution is less than the critical micelle concentration of the surfactant but the proteins are still effectively denatured. In some specific embodiments, when the surfactants used are sodium dodecyl sulfate or lithium dodecyl sulfate, the final concentration of the surfactant in the protein sample solution containing the protein sample, the surfactant and the chaotrope is less than about 0.07% w/v.

The protein sample solution may further comprise solvatochromic dyes. Such dyes help in visualizing the proteins in the electrophoretic system, thus aiding in the identification, and quantification of the proteins. Solvatochromic dyes useful in the invention include, but not limited to, merocyanine dyes, cyanine dyes, and squarylium dyes.

In some embodiments, the chaotrope, and the surfactants are added to the protein sample solution, and then subsequently mixed. The mixing step may be performed to ensure effective contact between the various components of the solution. This mixing may be effected for a time period ranging from about 0.5 seconds to about 5 minutes.

In further embodiments, the protein sample solution comprising the protein, chaotrope, and surfactant may be subjected to a heating step. A temperature range of from about 40° C. to about 90° C., and for a time period of from about 10 seconds to about 30 minutes may be employed.

The protein sample solution may further comprise a reducing agent. Reducing agents are frequently used to reduce the disulfide bonds of proteins, and, more generally, to prevent intramolecular, and intermolecular disulfide bonds from forming between cysteine residues of proteins. Exemplary reducing agents include β-mercaptoethanol, dithiothreitol and dithioerythritol.

Other dyes may also be used in the protein sample solution as a color marker to monitor the progress of the electrophoresis. Dyes are chosen such that they migrate in the same direction as the prepared protein under the effect of an electric field. Exemplary dyes that may be used for this purpose include, but not limited to, bromophenol blue, xylene cyanol, and orange G.

The protein sample solution may further comprise viscosity modifiers (e.g., as glycerol, polyethylene glycol, sucrose, or Ficoll®) that may be useful for sample loading onto vertical slab gels or other configurations in which sample loading is facilitated by gravity.

In another aspect, the invention provides an electrophoretic method for separating proteins using the method for protein sample preparation described herein. Thus, in one embodiment, the protein sample solution prepared as described herein is loaded onto an electrophoretic device. The electrophoretic device comprises a gel made of gel-forming materials such as starch, agarose, or polyacrylamide. The gels are typically prepared using a buffer with a pH ranging from about 5.0 to about 9.0.

The protein sample solution is prepared by providing a protein sample in solution, adding a chaotrope to the protein sample, and adding a surfactant to the protein sample, wherein the final concentration of the surfactant in the solution is less than critical micelle concentration of the surfactant.

The prepared protein sample solution may sometimes be mixed with a loading buffer prior to loading onto the gel. The loading buffer solution comprises a buffer of a suitable pH ranging from about 5.0 to about 9.0, and may further comprise other components such as, but not limited to dyes, and viscosity modifiers. Subsequently, the protein sample solution is loaded onto the gel. After loading the sample, an electric potential is applied which causes the sample to move across the gel. Different components of the samples move at different velocities depending on their size, thus allowing for separation of the proteins.

In yet another aspect, the invention provides a loading buffer solution that comprises a surfactant in solution, and a chaotrope. The surfactants in the loading buffer include anionic surfactants as described herein. The chaotrope is nonionic in nature, and may include urea, trimethyl amine N-oxide, and morpholine N-oxide. The surfactant is present at a concentration in the solution such that the final concentration of the surfactant in a solution, comprising a protein sample, chaotrope, and the surfactant, is less than critical micelle concentration of the surfactant. The loading buffer is used to prepare the protein sample solution, which is then used to load onto the electrophoretic device for separation, and analysis.

The loading buffer solution may further comprise components such as, but not limited to, dyes such as bromophenol blue; viscosity modifiers such as glycerol; reducing agents such as dithiothreitol.

In a further aspect, the invention provides a kit for preparing a protein sample solution for loading onto an electrophoretic device. The kit comprises a loading buffer solution as described herein. The individual components of the loading buffer solution, such as the surfactants, chaotropes, dyes, and the reducing agents in individual containers or as mixtures thereof. The kit may further comprise instructions for using the kit according to one or more of the methods provided herein.

### EXAMPLES

The SDS/Urea Sample Prep Buffer:

### 2× SDS Sample Buffer:

4 M urea
100 mM Tris, pH 6.8
0.1% Sodium dodecyl sulfate (SDS)
20% Glycerol
50 mM DTT (added fresh from frozen 1 M stock)
0.1% Bromophenol blue (BB).

The LDS/Urea Sample Prep Buffer:

### 2× LDS Sample Buffer:

4 M urea
100 mM Tris, pH 6.8
0.1% Lithium dodecyl sulfate (LDS)
20% Glycerol
50 mM DTT (added fresh from frozen 1 M stock)
0.1% Bromophenol blue

Gel Electrophoresis utilized the following components having the indicated compositions:

### Separating Gel:

2.41 mL 40% Acrylamide
1.3 mL 2% Bis-Acrylamide
2.5 mL 1.5M Tris, pH 8.8
3.74 mL water
50 μL 10% SDS
50 μL 10% Ammonium Persulfate
5 μL TEMED (N,N,N′,N′-Tetramethyl-1-,2-diaminomethane)

### Stacking Gel:

0.96 mL 40% Acrylamide
0.52 mL 2% Bis-Acrylamide
2.5 mL 0.5M Tris, pH 6.8
5.92 mL water
50 μL 10% SDS
50 μL 10% Ammonium Persulfate
10 μL TEMED
   When preparing gels, solutions are degased before addition of SDS, Ammonium Persulfate, and TEMED

### EXAMPLE 1

### CMC Assay

The CMC of a detergent is dependent on its environmental conditions, for example, the temperature, the concentration and salt content of buffers and chemicals present. To determine the CMC of a particular detergent in the presence of a specific buffer, a series of samples were created that contained the surfactant, buffer, and other chemicals that may be useful in the system (e.g., chaotrope such as urea). The concentrations of all chemicals, except the surfactant, were kept constant in all samples. The surfactant concentration was varied from 0% to a percentage expected to be above the CMC. The solvatochromic dye was added to each sample, the samples transferred to a 96-well plate, and the results read using a fluorescent plate reader and fluorescence intensity plotted against surfactant concentration. Typical CMC values plot along an “s-curve” the fluorescence intensity transitions upward sharply, then plateaus. The CMC is the detergent concentration at the mid-point of the transition.

### EXAMPLE 2

### Denaturation on PAGE.

Immunoglobulin G (IgG) protein samples with molecular weight of 150 kDa dissolved in common physiologic buffers (e.g., Tris-Buffered Saline) were mixed with an equal volume of 2× SDS or LDS sample prep buffer and heated at 90° C. for 1 minute in 0.2 mL polypropylene tubes in the wells of thermal cycler heat blocks. The lids were heated to minimize sample evaporation, to avoid consequent volume/concentration variability. The DTT, surfactant, and urea present in the sample buffer break the disulfide bonds in the IgG and unfold the protein upon heating. The result is that the IgG is separated into its corresponding high molecular weight and low molecular weight chains (50 kDa and 25 kDa chains, 2 of each). After heating, tubes were immediately transferred to a crushed ice bath until loading into the wells of a 10% polyacrylamide gel containing 0.05% SDS (see formulation above). Molecular weight standards were also included in a dedicated lane on the gels which were run at 180V until the bromophenol blue tracking dye was about to run off the gel (˜50 minutes). Gels were stained overnight with Sypro Ruby stain (Invitrogen) in accordance with the manufacturers instructions.

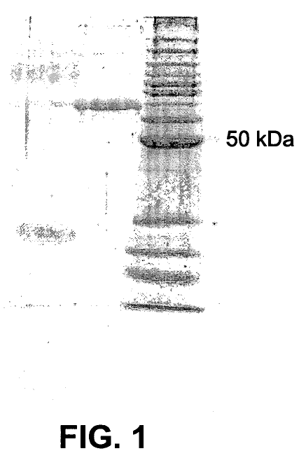

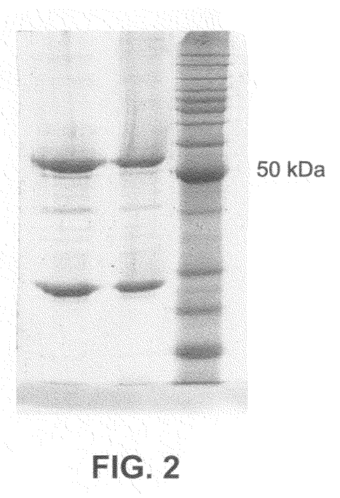

Images of stained gels were acquired on a Typhoon™ fluorescence imager (GE Healthcare). IgG protein samples prepared for electrophoresis in SDS sample buffer minus urea showed incomplete sample denaturation and incorrect electrophoretic migration as evidenced in FIG. 1. As demonstrated in FIG. 2, 0.05% LDS without urea showed improved but still incomplete denaturation. However, FIG. 2 demonstrates complete sample denaturation and correct electrophoretic migration when both 0.05% LDS and urea were used in the sample preparation.

### EXAMPLE 3

### Real-time Denaturation

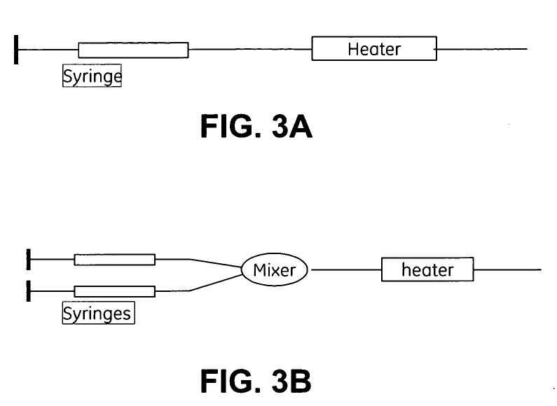

In a separate experiment, real-time sample denaturation was accomplished in one of two ways as shown in FIG. 3: (1) by pre-mixing the IgG protein sample with an equal volume of sample prep buffer and loading into a 500 μL Gastight™ syringe (Hamilton), and pumping the mixture using a Harvard syringe pump through a 100 μm i.d. borosilicate glass capillary at 20 μL/min through a water bath maintained at 90° C., in which varying lengths of tubing could be immersed thus varying the time of sample exposure to the bath temperature; (2) loading equal volumes of sample buffer, and the IgG protein sample in separate syringes, and pumping them into a microfluidic mixing device (Upchurch Scientific) connected to heated borosilicate glass tubing as described above. Denatured protein sample emerging from the distal end of the borosilicate glass tubing were delivered into collection tubes incubated in crushed ice, and then separated on polyacrylamide gels.

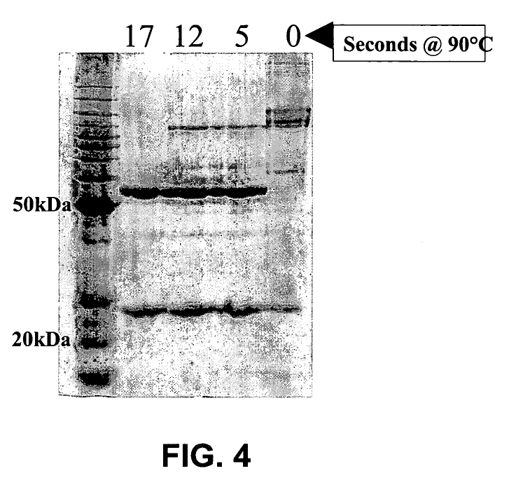

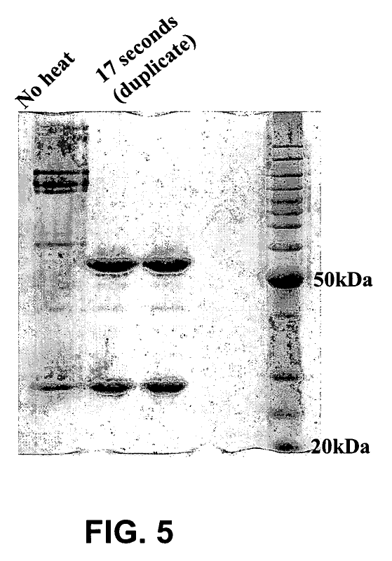

FIG. 4 shows the gel electrophoresis migration pattern that results from using method 1 above for heating times from 0-17 seconds. This FIG. shows that a minimum of approximately 17 seconds is necessary to achieve complete in-line denaturation. FIG. 5 shows the gel electrophoresis migration pattern that results from using method 2 above with 17 seconds of heating. These results confirm that the sample can be mixed and heated in-line resulting in complete denaturation and correct electrophoretic migration.

In summary, samples heated for ˜20 seconds in the presence of 0.05% LDS and 2M urea demonstrated adequate protein denaturation producing appropriate electrophoretic mobility when separated on polyacrylamide gels. This method of protein sample denaturation is also suitable for other modes of electrophoretic analysis including in capillaries, and micro-channels. In such instances glycerol may be omitted from the sample preparation buffer with no effect on sample denaturation.

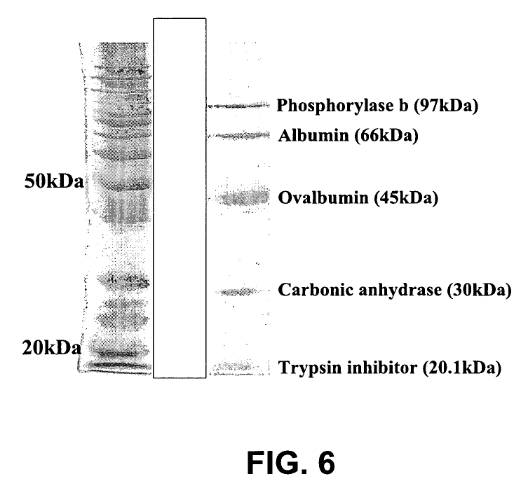

Because of the brief sample heating time (20 seconds) the method is compatible with real-time, flow-through sample preparation for automated protein electrophoretic analysis. This sample preparation method was attempted on other protein samples also. FIG. 6 shows that the electrophoretic migrations of all the proteins were correct.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A method for preparing a protein sample for electrophoresis comprising:
(a) providing a protein sample in solution;
(b) adding a chaotrope to the protein sample, and
(c) adding a surfactant to the protein sample, wherein the final concentration of the surfactant in the solution is less than critical micelle concentration of the surfactant.

2. The method of claim 1, wherein the protein has a molecular weight of at least about 10,000 Daltons.

3. The method of claim 1, wherein the sample solution comprises a buffer.

4. The method of claim 3, wherein the buffer comprises Tris-HCl.

5. The method of claim 1, wherein the chaotrope is nonionic.

6. The method of claim 5, wherein the chaotrope is urea, morpholine N-oxide, or trimethylamine N-oxide.

7. The method of claim 1, wherein the chaotrope has a final concentration in the protein sample solution containing the protein sample, the surfactant and the chaotrope of at least about 2 moles per liter.

8. The method of claim 1, wherein the surfactant is sodium dodecyl sulfate, lithium dodecyl sulfate, or mixtures thereof.

9. The method of claim 8, wherein the surfactant has a final concentration of less than about 0.07% w/v.

10. The method of claim 1, wherein the protein sample has a pH ranging from about 6 to about 8.

11. The method of claim 1, wherein the protein sample solution containing the protein sample, the surfactant, and the chaotrope further comprises a dye.

12. The method of claim 11, wherein the dye is a solvatochromic dye.

13. The method of claim 12, wherein the solvatochromic dye is a merocyanine dye, cyanine dye, or a squarylium dye.

14. The method of claim 1, further comprising the step of mixing the protein sample solution containing the protein sample, the surfactant, and the chaotrope.

15. The method of claim 1, further comprising the step of heating the protein sample solution containing the protein sample, the surfactant, and the chaotrope.

16. The method of claim 15, wherein the heating step is performed at a temperature range of from about 40° C. to about 90° C.

17. The method of claim 15, wherein the heating step is performed for a time period of from about 10 seconds to about 30 minutes.

18. An electrophoretic method comprising:
(a) providing a protein sample in solution;
(b) adding a chaotrope to the protein sample,
(c) adding a surfactant to the protein sample, wherein the final concentration of the surfactant in the solution is less than critical micelle concentration of the surfactant; and
(d) loading the sample solution of step (c) into an electrophoretic device and applying an electric current to the protein sample.

19. The method of claim 18, wherein the protein has a molecular weight of at least about 10,000 Daltons.

20. The method of claim 18, wherein the protein sample solution containing the protein sample, the surfactant, and the chaotrope includes a buffer.

21. The method of claim 20, wherein the buffer comprises Tris-HCl.

22. The method of claim 18, wherein the chaotrope is nonionic.

23. The method of claim 22, wherein the chaotrope is urea, morpholine N-oxide or trimethylamine N-oxide.

24. The method of claim 18, wherein the chaotrope is present in the protein sample solution at a final concentration of at least about 2 moles per liter.

25. The method of claim 18, wherein the surfactant is sodium dodecyl sulfate, lithium dodecyl sulfate, or mixtures thereof.

26. The method of claim 25, wherein the final concentration of the surfactant in the protein sample is less than about 0.07% weight/volume.

27. The method of claim 18, wherein the sample solution has a pH ranging from about 6 to about 8.

28. The method of claim 18, further comprising the step of adding a dye to the solution.

29. The method of claim 28, wherein the dye is a solvatochromic dye.

30. The method of claim 29, wherein the solvatochromic dye is a merocyanine dye, cyanine dye, or a squarylium dye.

31. The method of claim 18, further comprising the step of mixing the protein sample solution containing the protein sample, the surfactant, and the chaotrope.

32. The method of claim 18, wherein the step further comprises the step of heating the protein sample solution containing the protein sample, the surfactant, and the chaotrope.

33. The method of claim 32, wherein the protein sample solution is heated to a temperature range of from about 40° C. to about 90° C.

34. The method of claim 32, wherein the protein sample solution is heated for about 10 seconds to about 30 minutes.

35. A protein sample loading buffer composition comprising:
(a) a surfactant in solution at a final concentration of the surfactant in the solution is less than critical micelle concentration of the surfactant; and;
(b) a chaotrope
(c) a buffer.

36. The loading buffer composition of claim 35, wherein the surfactant is sodium dodecyl sulfate, lithium dodecyl sulfate, or combinations thereof.

37. The loading buffer composition of claim 36, wherein the surfactant has a final concentration of less than about 0.07% w/v.

38. The loading buffer composition of claim 35, wherein the chaotrope is nonionic.

39. The loading buffer composition of claim 38, wherein the chaotrope is urea, morpholine N-oxide, or trimethylamine N-oxide.

40. The loading buffer composition of claim 35, wherein the chaotrope is present in the protein sample solution containing the protein sample, the surfactant, and the chaotrope at a final concentration range of at least about 2 moles per liter.

41. The loading buffer composition of claim 35, wherein the buffer is Tris-HCl buffer.

42. The loading buffer composition of claim 35, wherein the composition has a pH ranging from about 6 to about 8.

43. An electrophoretic sample loading buffer kit comprising a composition of claim 35.
